(19) United States
(12) Patent Application Publication
(10) Pub. No.: US 2025/0315519 A1
(43) Pub. Date: Oct. 9, 2025

(54) SYSTEM AND METHOD FOR BUILDING AN ATTACK FLOW GRAPH

(71) Applicant: Accenture Global Solutions Limited, Dublin (IE)

(72) Inventors: Hodaya BINYAMINI, Be'er Sheva (IL); Gal ENGELBERG, Pardes Hanna-Karkur (IL); Dan KLEIN, Rosh Haayin (IL); Yael ZAMIR, Tel Aviv-Yafo (IL)

(73) Assignee: Accenture Global Solutions Limited, Dublin (IE)

(21) Appl. No.: 19/170,441

(22) Filed: Apr. 4, 2025

Related U.S. Application Data
(60) Provisional application No. 63/575,506, filed on Apr. 5, 2024.

(51) Int. Cl. G06F 21/55

(52) U.S. Cl. CPC G06F 21/55; G06F 2221/034

(57) ABSTRACT

System and method for generating an attack flow graph are disclosed. The method includes, receiving a cyber-attack report from a user device, extracting one or more attack actions from the cyber-attack report, extracting one or more attack assets from the cyber-attack report, determining one or more conditions and one or more operators associated with the one or more attack actions and the one or more attack assets. The method further includes, generating a subgraph using the one or more attack actions, the one or more attack assets, the one or more conditions and the one or more operators, generating an attack flow graph, wherein the attack flow graph is generated based on the subgraph, the cyber-attack report and an attack flow schema, and storing the attack flow graph in an attack flow knowledgebase.

### CROSS-REFERENCE TO RELATED APPLICATIONS

This application claims the benefit of U.S. Provisional Patent Application No. 63/575,506, filed on Apr. 5, 2024, the contents of which is incorporated herein by reference in its entirety.

### TECHNICAL FIELD

The present disclosure generally relates to the field of cyber security systems and, more particularly, to a system and a method for building an attack flow graph.

### BACKGROUND

Cyber-attacks are malicious attempts to access, damage, or disrupt computer systems, networks, or devices. The attacks may be in various forms including malwares, phishing, denials of service (DoS), etc. Cyber-attacks can target individuals, organizations, or government entities, leading to data breaches, financial losses, and reputational damage.

Every day, cybersecurity analysts identify potential attacks and document them in free-text reports. These reports detail the steps attackers take to achieve their malicious goals and can be used by defenders for mitigation analysis. While human readers can grasp the attackers' steps by reviewing these reports, it is challenging for systems to process this information effectively.

The attack flow is a data model that describes the sequence of an attacker's actions. In the attack flow project, security experts manually created attack flows based on known attacks. Using these flows make it easier to understand the steps, inputs, conditions, and results of an attack compared to reading a text-based report. However, the cybersecurity analysts face several challenges when translating free-text reports of potential attacks into attack flow formats that automated systems can process. The existing attack flow models, created manually by security experts, provide a representation of attack sequences but rely heavily on the expertise and skills of the individuals creating them. This dependency introduces variability in quality and consistency, as not all analysts possess the same level of skill or experience.

Additionally, the manual creation of attack flows is time-consuming and costly. Analysts must invest significant time in reviewing reports and constructing accurate models, which can delay response times to emerging threats. The reliance on human expertise also limits scalability, as organizations may not have enough skilled analysts to keep pace with the increasing volume of threats.

### SUMMARY

This summary is provided to introduce a selection of concepts in a simple manner that is further described in the detailed description of the disclosure. This summary is not intended to identify key or essential inventive concepts of the subject matter, nor it is intended for determining the scope of the disclosure.

A method for building an attack flow graph is disclosed. The method includes, receiving a cyber-attack report from a user device; extracting one or more attack actions from the cyber-attack report; extracting one or more attack assets from the cyber-attack report; and determining one or more conditions and one or more operators associated with the one or more attack actions and the one or more attack assets. The method further includes, generating a subgraph using the one or more attack actions, the one or more attack assets, the one or more conditions and the one or more operators; generating an attack flow graph, wherein the attack flow graph is generated based on the subgraph, the cyber-attack report and an attack flow schema; and storing the attack flow graph in an attack flow knowledgebase.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

Various embodiments in accordance with the present disclosure will be described with reference to the drawings, in which:

FIG. 1 an example environment for generating an attack flow graph, in accordance with implementations of the present disclosure;

FIG. 2 depicts a block diagram of the system for generating an attack flow graph, in accordance with an embodiment of the present disclosure;

FIG. 3 is a flowchart illustrating a method of generating an attack flow graph, in accordance with an embodiment of the present disclosure; and

FIG. 4 illustrates a computer system that may be used to implement the system of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” herein (e.g., “for example,” “an example of,” by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

As described, the cybersecurity analysts face several challenges when translating free-text reports of potential attacks into attack flow formats that automated systems can process. While human readers can comprehend the sequence of attacker actions from these reports, automated systems struggle to utilize the information effectively. The existing attack flow models, created manually by security experts, provide a representation of attack sequences but rely heavily on the expertise and skills of the individuals creating them. This dependency introduces variability in quality and consistency, as not all analysts possess the same level of skill or experience. To address one or more of such limitations, embodiments of the present disclosure describe a system and method for building an attack flow graph. Specifically, the system takes a cyber-attack report as an input and automatically generates an attack flow graph by analyzing the cyber-attack report and using one or more machine learning models (MLs), one or more large language models (LLMs), and/or one or more knowledgebases. In one embodiment, upon receiving the cyber-attack report, the system extracts one or more attack assets and one or more attack actions from the cyber-attack report and determines one or more conditions and one or more operators associated with the one or more attack actions and the one or more attack assets. Then the system determines one or more conditions, and one or more operators associated with the one or more attack actions and the one or more attack assets, and generates a subgraph using the one or more attack actions, the one or more attack assets, the one or more conditions and the one or more operators. Upon generating the subgraph, the system generates an attack flow graph based on the graph, the cyber-attack report and an attack flow schema. The system stores the attack flow graph in an attack flow knowledgebase. The attack flow knowledgebase storing a plurality of attack flows may be used by the experts or systems for various purpose including, but are not limited to, threat modeling incident response, vulnerability assessment, risk management, policy development, etc.

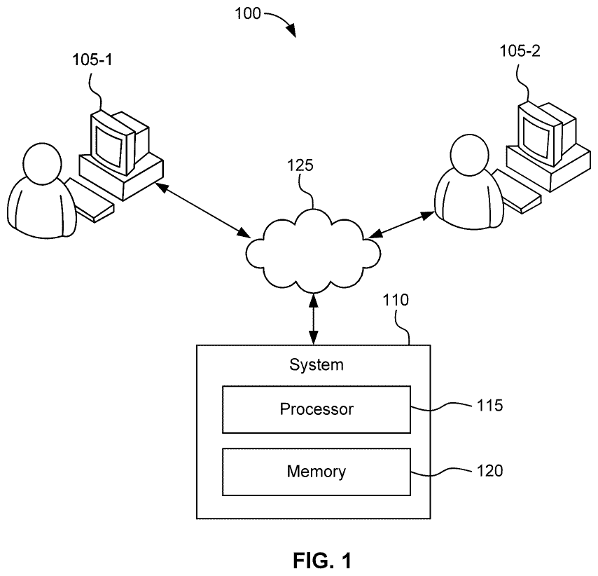

FIG. 1 an example environment for generating an attack flow graph, in accordance with implementations of the present disclosure. As shown, the environment 100 includes one or more user devices 105-1 and 105-2 (hereafter referred to as user device 105), a system 110 including a processor 115 and a memory 120, and a communication network 125. In one embodiment, the system 110 is configured for generating the attack flow graph, wherein the user device 105 and the system 110 are communicatively connected via the communication network 125. In some examples, the network 125 may include a Local Area Network (LAN), a Wide Area Network (WAN), the Internet, or a combination thereof. In some examples, the network may be accessed over a wired and/or a wireless communication link.

The user device 105 may be any electronic communication device associated with a user. In some examples, the user device 105 may include a desktop, laptops, a tablet, and/or the like. The user device 105 may present one or more user interfaces (e.g., Graphical User Interfaces (GUIs)) of a workspace for the user to interact with the system 110. The user device 105 may be used to provide input and/or receive output to/from the system 110. The input or the input data may include a cyber-attack report, and the output may include an attack flow generated for the given cyber-attack report. The cyber-attack report as described herein refers to a textual report detailing the nature of the attack and all steps of the attacker to gain the malicious goal.

In an embodiment, the system 110 may be implemented as an on-premises system that is operated by an enterprise or a third-party engaged in cross-platform interactions and data management. In some examples, the system 110 may be implemented as an off-premises system (for example, cloud or on-demand) that is operated by an enterprise or a third-party on behalf of an enterprise. In some examples, the system 110 may be implemented in a cloud environment. For simplicity, the system 110 depicted in FIG. 1 may be a cloud environment that is intended to represent various forms of servers including a web server, an application server, a proxy server, a network server, a server pool, and/or the like.

In some examples, the system 110 may be implemented by way of a single device or a combination of multiple devices that may be operatively connected or networked together. The system 110 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, two or more lines of code, or other suitable software structures operating in one or more software applications. Referring to FIG. 1, the system 110 includes the processor 115 and the memory 120 communicably coupled to the processor 115. The processor 115 may include one or more processors. Examples of the processor 115 may include, but are not limited to, microprocessors, microcomputers, microcontrollers, digital signal processors, central processing units, state machines, logic circuits, and/or any devices that manipulate data or signals based on operational instructions. Among other capabilities, the processor 115 may fetch instructions (also be referenced to as processor-executable instructions or machine-executable instructions) from the memory 120 and execute the fetched instructions for performing operations according to the present disclosure. The memory 120 may be non-volatile or non-transitory computer-readable medium (CRM) such as, a magnetic disk or solid-state non-volatile memory or volatile medium such as Random Access Memory (RAM), and/or the like.

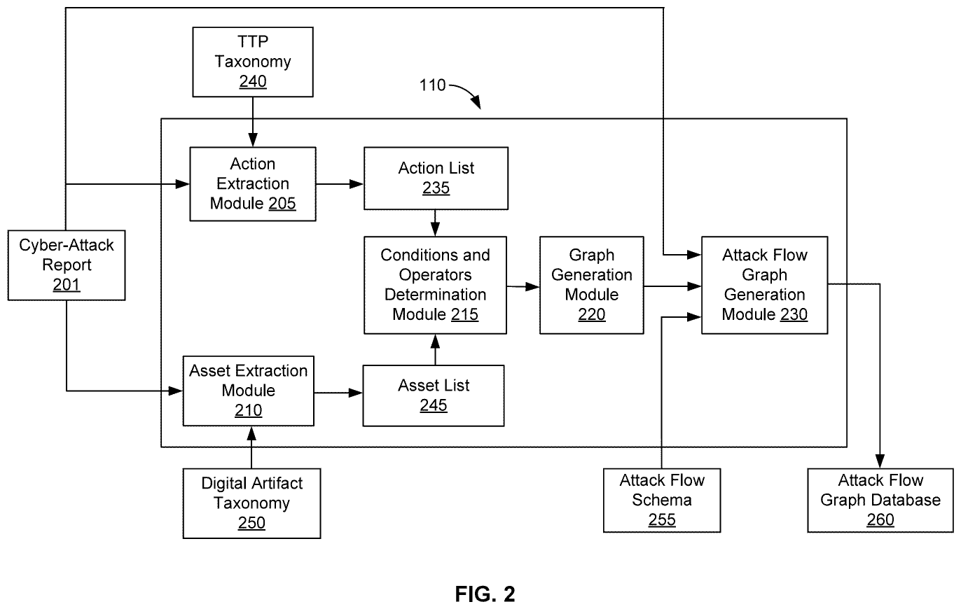

FIG. 2 depicts a block diagram of the system for generating an attack flow graph, in accordance with an embodiment of the present disclosure. As shown, the system 110 includes an action extraction module 205, an asset extraction module 210, a condition and operator determination module 215, a subgraph generation module 220 and an attack flow graph generation module 225.

As shown, the input to the system 110 is the cyber-attack report 201 generated by the experts. As described herein, the cyber-attack report 201 is a textual report detailing the nature of the attack and all steps of the attacker to gain the malicious goal. Hence, the cyber-attack report 201 includes executive summary of the attack including time, date, nature of attack etc., and incident details including, type of attack, duration of attack, target systems, assets, and/or actions, etc. The cyber-attack report 201 may further include impact details such as data compromised, operational and financial impact, and/or preventive measures, etc.

Upon receiving the cyber-attack report 201, the action extraction module 205 extracts one or more attack actions from the cyber-attack report 201. The attack actions as described herein refers to the one or more specific attack techniques that an adversary executes and may include, but are not limited to, phishing, malware deployment, scheduling tasks, and Denial of Service (DoS). In one embodiment of the present disclosure, the action extraction module 205 extracts the one or more attack actions from the cyber-attack report 201 using one of a first machine learning (ML) model and a first finetuned LLM. That is, in one embodiment of the present disclosure, the one or more attack actions are extracted using the first ML model. To train the first ML model, dataset of labeled cyber-attack reports is collected and the actions that needs to be extracted are labelled, for example, “phishing email,” “malware email”, etc. For example, the dataset includes pairs of <sentence, is attack action>. Hence, in one implementation, the labelled dataset may only include labels representing presence of an attack action, without highlighting the type of attack action. Then a natural language (NLP) model such as Bidirectional Encoder Representations from Transformers (BERT), or custom classifiers is selected and trained to extract actions from new cyber-attack reports. The first trained ML model's performance may be evaluated using metrics like precision, recall, and F1-score and implemented for extracting the one or more actions from the cyber-attack report 201.

In another embodiment of the present disclosure, the first finetuned LLM is used for extracting one or more attack actions from the cyber-attack report 201. Initially, a dataset of cyber-attack reports with labeled actions is collected, wherein the labels may include but are not limited to “malware deployment,” “phishing attempt,” etc. Then a pre-trained LLM such as BERT, GPT-3 is selected and finetuned on the labeled dataset using a suitable framework such as Hugging Face Transformers. The first finetuned LLM and the tokenizer are loaded for extracting the one or more attack actions from the cyber-attack report 201. Upon receiving the new cyber-attack report 201, the action extraction module 205 tokenizes the text and converts the text into the format expected by the first finetuned LLM and uses the first finetuned LLM to extract the one or more attack actions from the cyber-attack report 201. In another embodiment, the action extraction module 205 is configured to generate a prompt, based on the cyber-attack report, and the generated prompt is used for extracting the one or more attack actions using the first finetuned LLM. An example prompt may be “Extract all the attack actions from a vulnerability report. List all the actions from: {finding_report}” As described herein, the action extraction module 205 uses one of the first ML model and the first finetuned LLM for extracting the one or more attack actions from the cyber-attack report 201 and the output of the module is an action list 230 which lists all the attack actions present in the cyber-attack report 201.

In one embodiment of the present disclosure, upon extracting the one or more actions, the action extraction module 205 is further configured to assign a MITRE identifier (also referred to as MITRE ID) for each of the one or more attack actions. In one implementation, tactics, techniques, and procedures (TTP) framework 240 is used for assigning a MITRE identifier for each of the one or more attack actions. The TTP framework 240 is knowledge base that describes the actions adversaries take during an attack, organized into a matrix that reflects the tactics and techniques the adversaries use. The database includes tactics, each corresponding to a phase of an attack, techniques detailing how tactics are achieved, and MITRE ID assigned to each attack. It is to be noted that every type of attack is listed by MITRE. In one implementation, the action extraction module 205 performs semantic search to identify the MITRE identifier for each of the one or more attack actions.

In another embodiment, a second ML model is used for identifying a MITRE identifier for each of the attack actions. In this implementation, a dataset that includes examples of cyber-attack actions and their corresponding MITRE identifiers is collected using the resources such as MITRE ATT&CK framework and the dataset is structured as pairs of attack actions and MITRE IDs. Then the attack action text is converted into tokens using a tokenizer (for example Word2Vec, BERT tokenizer) suitable for the second ML model. Further, the MITRE IDs are converted into a numerical format. Then one of a ML model such as Recurrent Neural Networks (RNN), and transformers, is selected and trained on the dataset to identify a MITRE identifier for a given attack action.

In yet another embodiment, a second finetuned LLM is used for identifying MITRE identifier for each of the one or more attack actions. In this implementation, an LLM fine-tuned on a dataset that contains pairs of attack actions and their corresponding MITRE identifiers. The second finetuned LLM learns to associate specific attack actions with their correct MITRE identifiers by understanding the context and language patterns. The action extraction module 205 feeds the attack actions into the second finetuned LLM, which processes the text and predicts the corresponding MITRE identifiers.

Referring to FIG. 1, the asset extraction module 210 is configured to extract one or more attack assets from the cyber-attack report 201. The attack asset as described herein refers to a target or an asset that the attack action affects. The example attack asset may include, but are not limited to, a software, a file, a user credential, a corporate network, a database, and/or a user device.

In one embodiment of the present disclosure, the asset extraction module 210 extracts the one or more attack assets from the cyber-attack report 201 using a third machine learning (ML) model or a third finetuned LLM. That is, in one embodiment of the present disclosure, the one or more attack assets are extracted using the third ML model. The third ML model is trained using a dataset of collected and labeled cyber-attack assets, for example, “user credentials,” “database,” etc. Then a natural language (NLP) model such as BERT, or custom classifiers is selected and trained to extract assets from new cyber-attack reports. The third trained ML model's performance may be evaluated using metrics like precision, recall, and F1-score and implemented for extracting the one or more attack assets from the cyber-attack report 201. Upon receiving the cyber-attack report 201, the report is preprocessed to normalize data and fed to the third ML model which returns the one or more attack assets (attack asset names) used on the cyber-attack report 201.

In another embodiment of the present disclosure, the third finetuned LLM is used for extracting one or more attack assets from the cyber-attack report 201. Initially, a dataset of cyber-attack reports with labeled attack assets is collected, wherein the labels may include but are not limited to “user credentials,” “database,” “user device,” etc. Then a pre-trained LLM such as BERT, GPT-3 is selected and finetuned using the labeled dataset for a framework such as Hugging Face Transformers. The third finetuned LLM and the tokenizer are loaded for extracting the one or more attack assets from the cyber-attack report 201. Upon receiving the new cyber-attack report 201, the asset extraction module 205 tokenizes the text and converts the text into the format expected by the third finetuned LLM and uses the third finetuned LLM to extract the one or more attack assets from the cyber-attack report 201.

In another embodiment, the asset extraction module 210 is configured to generate a prompt, based on the cyber-attack report, and the generated prompt is used for extracting the one or more attack assets using the third finetuned LLM. As described herein, the asset extraction module 210 uses the third ML model or the third finetuned LLM for extracting the one or more attack assets from the cyber-attack report 201 and outputs an asset list 245 which lists all the attack assets present in the cyber-attack report 201.

In one embodiment, a digital artifact taxonomy 250 is used for categorizing the attack assets. The digital artifact taxonomy 250 provides a structured framework to categorize and analyze various digital artifacts, aiding in the identification of attack assets within cyber-attack reports. For example, upon extracting the asset name as “Accounting Server,” the asset extraction module 210 uses the digital artifact taxonomy 250 to categorize the asset, for example, as “Device.” As described herein, the asset extraction module 210 extracts the one or more attack assets from the cyber-attack report 201 and the output of the module 210 is the asset list 245 which lists all the attack actions present in the cyber-attack report 201.

Upon extracting the one or more attack actions and the one or more attack assets, the action list 235 and the asset list 245 are fed as input to the condition and operator determination module 215. In one embodiment of the present disclosure, the condition and operator determination module 215 determines the one or more conditions and the one or more operators associated with the one or more attack actions and the one or more attack assets. In one implementation, the module 215 determines the one or more conditions and the one or more operators using a fourth ML model. In another implementation, the module 215 determines the one or more conditions and the one or more operators using a fourth finetuned LLM.

In one embodiment, a dataset having the actions (the actions taken during the attack by the attacker), the asset (the assets affected), the description (a textual description of the attack), condition (the condition associated with the action), and the operator (the logical operator (e.g., AND, OR) is taken as a training dataset. Then the dataset is preprocessed to clean the dataset and to tokenize the textual description. Further, categorical variables (actions and assets) are converted into numerical format, for example using one-hot encoding and techniques such as Term Frequency-Inverse Document Frequency (TF-IDF) or Word Embeddings (e.g., Word2Vec) are used for text features. Then an appropriate model such as a multi-label classification model implemented by random forest model and/or neural network model is selected and trained using the dataset. Further, metrics such as accuracy, precision, recall, and F1 score are used to evaluate performance of the fourth ML model and deployed for determining the one or more conditions and the one or more operators associated with the one or more attack actions and the one or more attack assets. The condition and operator determination module 215 takes the cyber-attack report 201, action list 235 and the asset list 235 as the input and determines the one or more conditions and the one or more operators associated with the one or more attack actions and the one or more attack assets using the fourth ML model.

In another embodiment, the fourth finetuned LLM is used for determining the one or more conditions and the operators. In this implementation, a dataset having the labelled actions the assets, the description, the condition and the operator is taken as a training dataset. The dataset is then normalized, the text is converted into tokens that the LLM can process, and embeddings are created for the actions and assets in the dataset. Then a pretrained LLM such as GPT, BERT, or similar model is selected and finetuned on the training dataset. Upon receiving the new cyber-attack report 201, the action list 235 and the asset list 245, the condition and operator determination module 215 tokenizes the text and converts the text into the format expected by the fourth finetuned LLM and uses the furth finetuned LLM to extract the one or more conditions and the one or more operators. In another embodiment, the condition and operator determination module 215 is configured to generate a prompt, based on the action list 235 and the asset list 245, and the generated prompt is used for extracting the one or more conditions and operators using the fourth finetuned LLM. As described herein, the condition and operator determination module 215 uses one of the fourth ML model and the fourth finetuned LLM for determining the one or more conditions and operators.

In one embodiment of the present disclosure, upon determining the one or more conditions and the one or more operators, the subgraph generation module 220 generates a subgraph using the one or more attack actions (the attack action list 235), the one or more attack assets (the attack asset list 245), the one or more conditions and the one or more operators. The subgraph represents relationships between the one or more attack actions, the one or more assets, the one or more conditions, and the one or more operators. The node of the graph represents the attack actions, the attack assets, the conditions and the operators, and the edges connects attack actions to attack assets, and connects the conditions to attack actions and assets using the specified operators. Hence, the subgraph includes the relationships if there are any and also all the attack actions, the attack assets, the conditions and the operators.

Upon generating the subgraph, the attack flow graph generation module 230 generates an attack flow graph based on the generated subgraph, the cyber-attack report 201 and an attack flow schema 255. The attack flow schema 255 is a structured framework or blueprint that outlines how data or information is to be organized and represented, and defines the structure and rules for valid data, including element types, attributes, and relationships. In the present implementation, the attack flow schema 255 defines the entry point on how the attack is initiated, conditions, operators, attack actions and outcomes. Based on the attack flow schema 255, properties for each of node of the graph is updated using the cyber-attack report 201 to generate the attack flow graph. For example, based on the schema, relevant properties are added to each node. The properties include, but are not limited to, unique identifier (ID) for each stage in the attack flow, purpose for referencing each stage, description explaining the process at each stage, relationship between the IDs, and tools used in the attack. Such information is added while generating the attack flow graph by referring to the attack flow schema 255 and using the generated subgraph, the cyber-attack report 201. The generated attack flow graph is stored in an attack flow graph database 260. The attack flow graph database 260 (attack flow knowledgebase) storing a plurality of attack flow graphs may be used by the experts or systems for various purpose including, but are not limited to, threat modeling incident response, vulnerability assessment, risk management, policy development, etc. In one embodiment, the attack flow graph is a structured graph and generated in JSON format. However, the attack flow graph may be generated in any other know formats.

In one embodiment of the present disclosure, the attack flow graph generation module 230 is further configured to validate the generated attack flow graph. The graph generation module 230 uses a graph validator which validates the generated attack flow graph based on the attack flow schema 255. The graph validator checks the integrity, structure, and relationships within the generated attack flow graph to ensures that the graph adheres to specified rules or constraints of the attack flow schema 255. The validation includes, but are not limited to, ensuring that all nodes and edges have unique IDs, verifying edges and nodes, and ensuring connectivity. In one implementation, graph edit distance-based method is used for evaluating the generated attack flow graph. The evaluation measures how similar two graphs, the generated attack flow graph and the attack flow schema 255, are by calculating the minimum number of edit operations (additions, deletions, substitutions) needed to transform one graph into another graph. Further, a similarity score may be assigned for the nodes based on the types of nodes present in each graph and by calculating Jaccard distance. Further, graph embeddings of the nodes of both the graphs may be used to calculate the cosine similarity or Euclidean distance between the embeddings of nodes in different graphs and the score may be used for validating the generated attack flow graph.

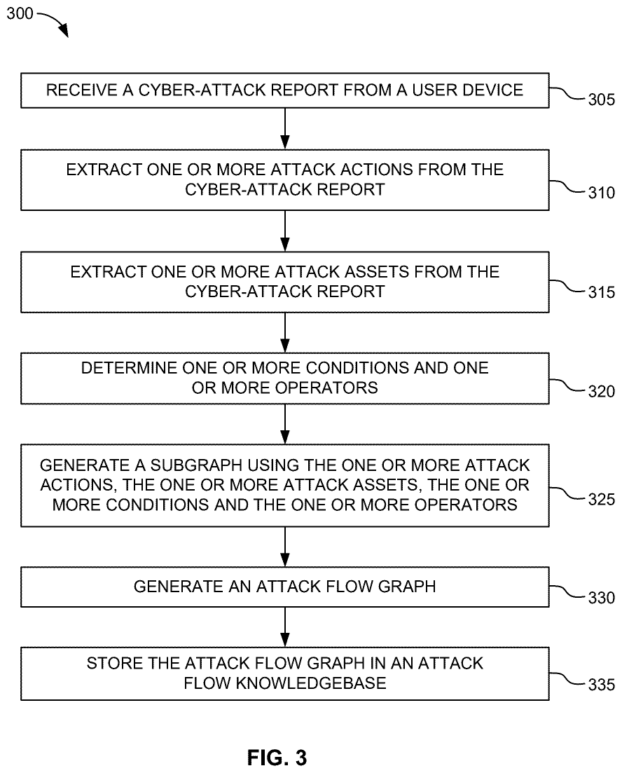

FIG. 3 is a flowchart illustrating a method of generating an attack flow graph, in accordance with an embodiment of the present disclosure. Initially, at step 305, the system 110 receives a cyber-attack report 201 from a user device 105. the cyber-attack report 201 is a textual report detailing the nature of the attack and all steps of the attacker to gain the malicious goal. Hence, the cyber-attack report 201 includes executive summary of the attack including time, date, nature of attack etc., and incident details including, type of attack, duration of attack, target systems, assets, actions, etc. The cyber-attack report 201 may further include impact details such as data compromised, and operational and financial impact, preventive measures, etc.

At step 310, the system 110 extracts the one or more attack actions from the cyber-attack report 201. As described herein, the one or more attack actions are extracted from the cyber-attack report 201 using one of a first machine learning model and a first finetuned LLM. Further, the system 110 assigns a MITRE identifier for each of the one or more attack actions using a TTP framework and outputs the attack action list for further processing.

At step 315, the system 110 further extracts the one or more attack assets from the cyber-attack report 201. As described herein, the one or more attack assets are extracted from the cyber-attack report 201 using one of a third machine learning model and a third finetuned LLM. The one or more attack assets as described herein refers to target asset names such as credentials, database, server, user system, email server, etc.

At step 320, the system 110 determines one or more conditions and one or more operators associated with the one or more attack actions and the one or more attack assets. In one embodiment, the system 110 uses a fourth ML model or the fourth finetuned LLM for determining the one or more conditions and one or more operators associated with the one or more attack actions and the one or more attack assets.

At step 325, the system 110 generates a subgraph using the one or more attack actions, the one or more attack assets, the one or more conditions and the one or more operators. The subgraph lists all elements such as attack actions, the assets, the conditions and the operators and also represents the relationship between them.

At step 330, the system 110 an attack flow graph. In one embodiment, the system 110 generates the attack flow graph based on the subgraph, the cyber-attack report 201 and an attack flow schema 255. The generated attack flow graph is then stored in the attack flow graph database 260, as shown at step 335. The attack flow graph database 260 storing a plurality of attack flow graphs may be used by the experts or systems for various purpose including, but are not limited to, threat modeling incident response, vulnerability assessment, risk management, policy development, etc.

The system and method described in the present disclosure automatically builds an attack flow graph for a given cyber-attack textual report by extracting all the relevant objects and patterns by the attack flow schema. Also, the system evaluates the quality of the generated attack-flow graph given a known attack flow schema for the same attack.

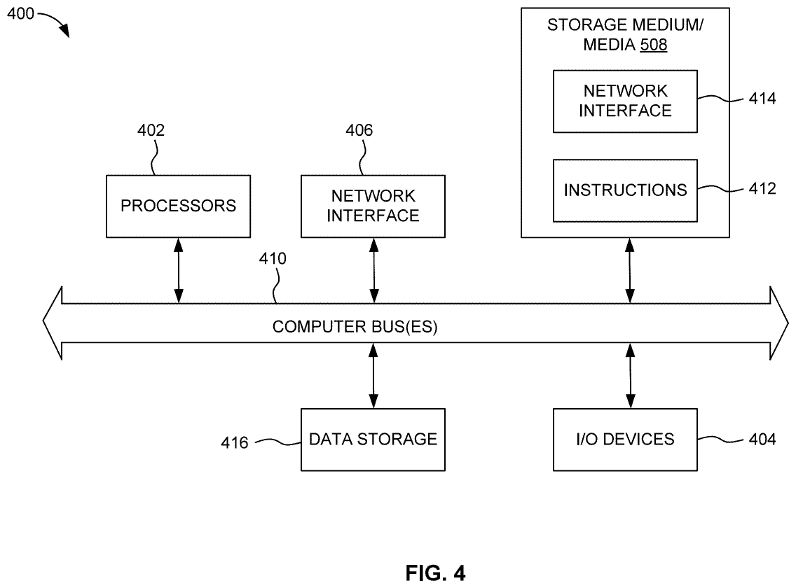

FIG. 4 illustrates a computer system 400 that may be used to implement the system 110. More particularly, computing machines such as desktops, laptops, and other computing devices which may be used to process the conversational interactions in the system 110 may have the structure of the computer system 400. The computer system 400 may include additional components not shown and that some of the process components described may be removed and/or modified. In another example, a computer system 400 may be deployed on external-cloud platforms such as cloud, internal corporate cloud computing clusters, organizational computing resources, and/or the like.

The computer system 400 includes processor(s) 402, such as a central processing unit, ASIC or another type of processing circuit, input/output devices 404, such as a display, mouse keyboard, etc., a network interface 406, such as a Local Area Network (LAN), a wireless 802.11x LAN, a 3G or 4G mobile WAN or a WiMax WAN, and a processor-readable medium 408. Each of these components may be operatively coupled to a bus 410.

The computer-readable medium 408 may be any suitable medium that participates in providing instructions to the processor(s) 402 for execution. For example, the computer-readable medium 408 may be non-transitory or non-volatile medium, such as a magnetic disk or solid-state non-volatile memory or volatile medium such as RAM. The instructions or modules stored on the computer-readable medium 408 may include machine-readable instructions 412 executed by the processor(s) 402 that cause the processor(s) 402 to perform the methods and functions of the system 110.

The system 110 may be implemented as software stored on a non-transitory processor-readable medium and executed by the processors 402. For example, the computer-readable medium 408 may store an operating system 414, such as MAC OS, MS WINDOWS, UNIX, or LINUX, and code for the system 110. The operating system 414 may be multi-user, multiprocessing, multitasking, multithreading, real-time, and the like. For example, during runtime, the operating system 414 is running and the code for the system 110 is executed by the processor(s) 402.

The computer system 400 may include a data storage 416, which may include non-volatile data storage. The data storage 416 stores any data used or generated by the system 110. The network interface 406 connects the computer system 400 to internal systems for example, via a LAN. Also, the network interface 406 may connect the computer system 400 to the Internet. For example, the computer system 400 may connect to web browsers and other external applications and systems via the network interface 406.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in a generic classical processor system and a quantum computing system.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method comprising:
receiving, by a processor, a cyber-attack report from a user device;
extracting, by the processor, one or more attack actions from the cyber-attack report;
extracting, by the processor, one or more attack assets from the cyber-attack report;
determining, by the processor, one or more conditions and one or more operators associated with the one or more attack actions and the one or more attack assets;
generating, by the processor, a subgraph using the one or more attack actions, the one or more attack assets, the one or more conditions and the one or more operators;
generating, by the processor, an attack flow graph, wherein the attack flow graph is generated based on the subgraph, the cyber-attack report and an attack flow schema; and
storing, by the processor, the attack flow graph in an attack flow knowledgebase.

2. The computer-implemented method of claim 1, wherein the one or more attack actions are extracted from the cyber-attack report using one of a first machine learning model and a first finetuned LLM.

3. The computer-implemented method of claim 1, the method further comprises, assigning a MITRE identifier for each of the one or more attack actions using a TTP framework.

4. The computer-implemented method of claim 3, wherein the MITRE identifier is identified using one of a second machine learning model, a second finetuned large language model (LLM), and a semantic search on a vector database.

5. The computer-implemented method of claim 1, wherein the one or more attack assets are extracted from the cyber-attack report using one of a third machine learning model and a third finetuned LLM.

6. The computer-implemented method of claim 1, wherein the one or more conditions and the one or more operators associated with the one or more attack actions and the one or more attack assets are determined using one of a fourth machine learning model and a fourth finetuned LLM.

7. The computer-implemented method of claim 1, wherein generating the attack flow graph comprises, adding properties for each of node of graph, wherein the properties are added based on the attack flow schema and using the cyber-attack report.

8. The computer-implemented method of claim 1, wherein the attack flow graph is generated in a structured format.

9. The computer-implemented method of claim 1, further comprises, evaluating, by the processor, the attack flow graph using a graph validator.

10. A system comprising:
at least one memory configured to store machine-executable instructions; and
at least one processor communicatively coupled with the at least one memory, and configured to execute the machine-executable instructions to perform operations comprising:
receiving a cyber-attack report from a user device;
extracting one or more attack actions from the cyber-attack report;
extracting one or more attack assets from the cyber-attack report;
determining one or more conditions and one or more operators associated with the one or more attack actions and the one or more attack assets;
generating a subgraph using the one or more attack actions, the one or more attack assets, the one or more conditions and the one or more operators;
generating an attack flow graph, wherein the attack flow graph is generated based on the subgraph, the cyber-attack report and an attack flow schema; and
storing the attack flow graph in an attack flow knowledgebase.

11. The system of claim 10, wherein the one or more attack actions are extracted from the cyber-attack report using one of a first machine learning model and a first finetuned LLM.

12. The system of claim 10, wherein the processor is further configured to execute machine-executable instructions to perform operations comprising, assigning a MITRE identifier for each of the one or more attack actions using a tactics, techniques, and procedures (TTP) framework.

13. The system of claim 12, wherein the MITRE identifier is identified using one of a second machine learning model, a first finetuned large language model (LLM), and a semantic search on a vector database.

14. The system of claim 10, wherein the one or more attack assets are extracted from the cyber-attack report using one of a third machine learning model and a third finetuned LLM.

15. The system of claim 10, wherein the one or more conditions and the one or more operators associated with the one or more attack actions and the one or more attack assets are determined using one of a fourth machine learning model and a fourth finetuned LLM.

16. The system of claim 10, wherein generating the attack flow graph comprises, adding properties for each of node of the graph, wherein the properties are added based on the attack flow schema and using the cyber-attack report.

17. The system of claim 10, wherein the attack flow graph is generated in a structured format.

18. The system of claim 10, wherein the processor is further configured to evaluate the attack flow graph using a graph validator.

19. At least one non-transitory computer-readable media comprising machine-executable instructions stored thereon, which, when executed by at least one processor of at least one computing device, cause the at least one computing device to perform operations comprising:
receiving a cyber-attack report from a user device;
extracting one or more attack actions from the cyber-attack report;
extracting one or more attack assets from the cyber-attack report;
determining one or more conditions and one or more operators associated with the one or more attack actions and the one or more attack assets;
generating a subgraph using the one or more attack actions, the one or more attack assets, the one or more conditions and the one or more operators;
generating an attack flow graph, wherein the attack flow graph is generated based on the subgraph, the cyber-attack report and an attack flow schema; and
storing the attack flow graph in an attack flow knowledgebase.
